(19) United States
(12) Patent Application Publication
(10) Pub. No.: US 2003/0118189 A1
(43) Pub. Date: Jun. 26, 2003

(54) Encryption processing apparatus, encryption processing unit control apparatus, encryption processing unit, and computer product

(75) Inventors: Toshiaki Ibi, Kawasaki (JP); Shoki Kadowaki, Kawasaki (JP); Tomoaki Hoshi, Kawasaki (JP); Yasuyuki Higashiura, Kawasaki (JP); Takumi Kishino, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/101,274

(22) Filed: Mar. 20, 2002

(30) Foreign Application Priority Data
Dec. 20, 2001 (JP) 2001-388439

(51) Int. Cl. H04L 9/00

(52) U.S. Cl. 380/277

(57) ABSTRACT

The encryption processing apparatus includes a plurality of encryption processing units each of which executes an encryption processing. One encryption processing unit generates a key, encrypts the key, and delivers the encrypted key to the other encryption processing units. Each of the other encryption processing units decodes the received key and stores the key so that the keys stored in all the encryption processing units is same.

### FIELD OF THE INVENTION

The present invention relates to an encryption processing apparatus, an encryption processing unit control apparatus, an encryption processing unit, and a computer program capable of dispersing encryption processing load.

### BACKGROUND OF THE INVENTION

In recent years, various techniques have been studied to deal with dangers such as the tapping and falsification of information by the third party and disguise in an open network such as phone line, ISDN (Integrated Services Digital Network), LAN (Local Area Network), radio communication network, optical communication network or the like.

As the most typical example, there is known an encryption technique encrypting a plain text encrypted according to an encryption algorithm such as RSA (Rivest Shamir Adleman) or DES (Data Encryption Standard) and using the cipher text for the transmission thereof on an actual network or the storage thereof in an information terminal.

An encryption processing system employing the encryption technique of this type includes an encryption processing section which encrypts a plain text to a cipher text, and a decoding processing section which decodes the cipher text to the plain text and uses a key encryption and decoding. It is, therefore, essential to the encryption processing system to strictly manage the key so as to prevent the interpretation of information by the leakage of the key to the outside of the system.

FIG. 22 is a block diagram which shows the configuration of a conventional encryption processing system. In FIG. 22, an encryption processing apparatus 10 mounts thereon n encryption processing units 20₀ to 20ₙ the security of which is protected. This encryption processing apparatus 10 is intended to encrypt a plain text input from the outside of the apparatus, to decode a cipher text, to generate key for encryption and decoding and the like.

A driver 40 controls the driving of the encryption processing units 20₀ to 20ₙ through a PCI (peripheral component interconnect) bus 30 in accordance with an instruction from a master apparatus 50. The master apparatus 50 is a computer apparatus which executes an application program for encryption and decoding and issues various instructions to the driver 40 in relation to the generation of a key, encryption and decoding.

Each of the encryption processing units 20₀ to 20ₙ has a function of generating a key used for encryption and decoding under the control of the driver 40, a function of issuing a key ID identifying the key, a function of encrypting a plain text according to an encryption algorithm (e.g., RSA or DES) using the key, and a function of decoding a cipher text using the key.

FIG. 23 is a block diagram which shows the configuration of the encryption processing units 20₀ and 20₁ shown in FIG. 22. In FIG. 23, the same reference symbols denote the same or corresponding constituent elements as those in FIG. 22. In the encryption processing unit 20₀ shown in FIG. 23, a security guard 21₀ has a function of detecting an external attack (such as a physical destruction intended to illegally acquire a key) and a function of forcedly deleting the key held in the unit when the external attack is detected.

A PCI control section 22₀ controls the PCI bus 30 which is a communication interface between the driver 40 (see FIG. 22) and the encryption processing unit 20₀. A control section 23₀ consists of an MPU (Micro Processing Unit) which executes a program and controls the respective sections, an ROM (Read Only Memory) which serves as a storage region, a RAM (Random Access Memory) and the like.

A timer section 24₀ is a real-time clock which momently outputs time information to a key generation section 250. The key generation section 25₀ generates a unique key 60ₙ using random numbers, time information, an integration timer or the like in accordance with an key generation instruction. In addition, the key generation section 25₀ transmits a key ID 61₀ (see FIG. 24) identifying the key 60₀ to the driver 40. The RAM 26₀ stores the key while making the key correspond to the key ID.

It should be noted herein that the key ID 61₀ is transmitted from the encryption processing unit 20₀ to the outside and that the key 60₀ itself is not transmitted. As can be seen, according to the conventional encryption processing system, the generation and storage of the key are closed in the encryption processing unit 20₀ to prevent the key from being leaked to the outside, thereby maintaining high security.

A battery 27₀ is the backup power supply of the timer section 24₀ and the RAM 26₀. An encryption/decoding processing section 28₀ has a function of encrypting a plain text to a cipher text in accordance with an external instruction and the key ID using the key corresponding to the key ID, and a function of decoding the cipher text using the key.

The encryption processing unit 20₁ is the same in configuration as the encryption processing unit 20₀ explained above. That is, the encryption processing unit 20₁ consists of a security guard 21₁, a PCI control section 22₁, a control section 23₁, a timer section 24₁, a key generation section 25₁ which generates a key 60₁, a RAM 26₁, a battery 27₁ and an encryption/decoding section 28₁.

The key 60₀ generated by the key generation section 25₀ in the encryption processing unit 20₀ is different from the key 60₁ generated by the key generation section 25₁ in the encryption processing unit 20₁. Therefore, the cipher text generated by the encryption processing unit 20₀ can be decoded only by the encryption processing unit 20₀ and cannot be decoded by the encryption processing unit 20₁.

The other encryption processing units (units 20₂ (not shown) to 20ₙ are the same in configuration as the encryption processing unit 20₀ explained above. It is noted, however, that the keys generated by these other encryption processing units are unique to their respective units.

The key generation processing of the conventional encryption processing system will next be explained with reference to FIG. 24. When a key generation instruction 70₀ corresponding to the encryption processing unit 20₀ is issued from the master apparatus 50, the driver 40 requests the encryption processing unit 20₀ to generate a key.

In response to the request, the key generation section 25₀ generates the key 60₀ and the key ID 61₀, and the key 60₀ and the key ID 61₀ thus generated are stored in the RAM 26₀ (see FIG. 23). The key generation section 25₀ then transmits the key ID 61₀ to the driver 40. This key ID 61₀ is delivered by the driver 40 to the master apparatus 50.

Thereafter, when a key generation instruction 70₁ corresponding to the encryption processing unit 20₁ is issued from the master apparatus 50, the driver 40 request the encryption processing unit 20₁ to generate a key.

In response to the request, the key generation section 25₁ generates the key 60₁ and the key ID 61₁, and the key 60₁ and the key ID 61₁ thus generated are stored in the RAM 26₁ (see FIG. 23). The key generation section 25₁ then transmits the key ID 61₁ to the driver 40. This key ID 61₁ is delivered by the driver 40 to the master apparatus 50.

The encryption processing of the conventional encryption processing system will next be explained with reference to FIG. 25. When an encryption instruction 71₀ corresponding to the encryption processing unit 20₀ is issued from the master apparatus 50, the driver 40 requests the encryption processing unit 20₀ to perform encryption. In addition, a plain text 72₀ and the key ID 61₀ are delivered to the encryption processing unit 20₀ from the master apparatus 50.

In response to the request, the encryption/decoding processing section 28₀ encrypts the plain text 72₀ to a cipher text 73₀ using the key 60₀ corresponding to the key ID 61₀ and transmits the cipher text 73₀ to the driver 40. This cipher text 73₀ is delivered to the master apparatus 50 by the driver 40.

When an encryption instruction 71₁ corresponding to the encryption processing unit 20₁ is issued from the master apparatus 50, the driver 40 requests the encryption processing unit 20₁ to perform encryption. In addition, a plain text 72₁ and the key ID 61₁ are delivered to the encryption processing unit 20₁ from the master apparatus 50.

In response to the request, the encryption/decoding processing section 28₁ encrypts the plain text 72₁ to a cipher text 73₁ using the key 60₁ corresponding to the key ID 61₁ and transmits the cipher text 73₁ to the driver 40. This cipher text 73₁ is delivered to the master apparatus 50 by the driver 40.

The decoding processing of the conventional encryption processing system will next be explained with reference to FIG. 26. When a decoding instruction 74₀ corresponding to the encryption processing unit 20₀ is issued from the master apparatus 50, the driver 40 request the encryption processing unit 20₀ to perform decoding. In addition, the cipher text 73₀ and the key ID 61₀ are delivered to the encryption processing unit 20₀ from the master apparatus 50.

In response to the request, the encryption/decoding processing section 28₀ decodes the cipher text 73₀ to the plain text 72₀ using the key 60₀ corresponding to the key ID 61₀ and transmits the plain text 72₀ to the driver 40. The driver 40 delivers this plain text 72₀ to the master apparatus 50.

When a decoding instruction 74₁ corresponding to the encryption processing unit 20₁ is issued from the master apparatus 50, the driver 40 request the encryption processing unit 20₁ to perform decoding. In addition, the cipher text 73₁ and the key ID 61₁ are delivered to the encryption processing unit 20₁ from the master apparatus 50.

In response to the request, the encryption/decoding processing section 28₁ decodes the cipher text 73₁ to the plain text 72₁ using the key 60₁ corresponding to the key ID 61₁ and transmits the plain text 72₁ to the driver 40. The driver 40 delivers this plain text 72₁ to the master apparatus 50.

According to the conventional encryption processing system, a key ID and an encryption processing unit have a one-to-one correspondence. Therefore, if the corresponding encryption processing unit is executing a different processing when an encryption processing or a decoding processing (which will be generally referred to as “encryption processing” hereinafter) is requested, the corresponding encryption processing unit turns into a busy (processing wait) state until the unit is completed with the different processing.

Specifically, when the encryption instruction 71₀ is issued to the encryption processing unit 20₀ shown in FIG. 25 and the encryption processing unit 20₀ has been executing a different processing, then the encryption processing unit 20₀ does not start an encryption processing based on the encryption instruction 71₀ and turns into a busy state until completing with this different processing.

Since a key ID and an encryption processing unit have a one-to-one correspondence in the conventional encryption processing system, it is impossible to request an encryption processing to the other encryption unit (e.g., encryption processing unit 20₁) while the unit 20₀ is in a busy state. The same problem occurs to the decoding processing.

In this way, the conventional encryption processing system is disadvantageously incapable of dispersing load related to an encryption processing or a decoding processing although the n encryption processing units 20₀ to 20ₙ are mounted on the encryption processing apparatus 10. In addition, there is a high probability that the encryption processing or the decoding processing is concentrated on a specific one encryption processing unit.

### SUMMARY OF THE INVENTION

It is an object of the present invention to provide an encryption processing apparatus, an encryption processing unit control apparatus, an encryption processing unit, and a computer program capable of dispersing encryption processing load.

The encryption processing apparatus according to one aspect of the present invention comprises a plurality of encryption processing units each of which executes an encryption processing. At least one of the encryption processing units generates a key, encrypts the key and delivers the encrypted key to other encryption processing units that have not generated the key. Each of the other encryption processing units decodes the received key, and stores the key as the key that is the same key as the one generated by the at least one encryption processing unit.

The encryption processing unit control apparatus according to another aspect of the present invention comprises an encrypted key generation instruction unit which issues an instruction to generate a key, encrypt the generated key and transmit the encrypted key, to a specific encryption processing unit among a plurality of encryption processing unit each of which executes an encryption processing, and an encrypted key decoding unit which issues an instruction to deliver the encrypted key, decode the encrypted key and hold the same key as the key generated by the specific encryption processing unit, to the other encryption processing units.

The encryption processing control unit according to still another aspect of the present invention comprises a key generation unit which generates a key in accordance with an external key generation instruction, an encrypted key generation unit which generates an encrypted key obtained by encrypting the key to be delivered to the other encryption processing units based on an external encrypted key generation instruction, and then transmits the encrypted key to an outside of the encrypted key generation unit, and an encrypted key decoding unit which decodes the delivered encrypted key and holds the same key as the key held by the encryption processing unit which generates the key based on an external encrypted key decoding instruction.

Other objects and features of this invention will become apparent from the following description with reference to the accompanying drawings.

### BRIEF DESCRIPTION OF THE DRAWINGS

FIG. 1 is a block diagram which shows the configuration of one embodiment according to the present invention,

FIG. 2 is a block diagram which shows the configurations of encryption processing units 200₀ and 200₁ shown in FIG. 1,

FIG. 3 is an explanatory view which explains the outline of a key management table 700 used in this embodiment,

FIG. 4 shows the key management table 700 used in this embodiment,

FIG. 5 shows key sequence information 800 used in this embodiment,

FIG. 6 is a flow chart which explains the operation of a driver 400 shown in FIG. 1,

FIG. 7 is a flow chart which explains an encrypted key generation processing shown in FIG. 6,

FIG. 8 is a flow chart which explains an encryption/decoding processing shown in FIG. 6,

FIG. 9 is a flow chart which explains a key consistency processing shown in FIG. 6,

FIG. 10 is a flow chart which explains the key consistency processing shown in FIG. 6,

FIG. 11 is a flow chart which explains the operation of the encryption processing unit 200₀ shown in FIG. 1,

FIG. 12 is a flow chart which explains an encrypted key generation processing shown in FIG. 11,

FIG. 13 is a flow chart which explains the encryption/decoding processing shown in FIGS. 11 and 16,

FIG. 14 is a flow chart which explains a sequence processing shown in FIGS. 11 and 16,

FIG. 15 is a flow chart which explains a key consistency processing shown in FIGS. 11 and 16,

FIG. 16 is a flow chart which explains the operations of the encryption processing units 200₁ to 200ₙ shown in FIG. 1,

FIG. 17 is a flow chart which explains an encrypted key decoding processing shown in FIG. 16,

FIG. 18 shows integrated key sequence information 900 used in this embodiment,

FIG. 19 shows the first example of the key consistency processing shown in FIG. 15,

FIG. 20 shows the second example of the key consistency processing shown in FIG. 15,

FIG. 21 is a block diagram which shows the configuration of the modification of this embodiment,

FIG. 22 is a block diagram which shows the configuration of a conventional encryption processing system,

FIG. 23 is a block diagram which shows the configurations of encryption processing units 20₀ and 20₁ shown in FIG. 22,

FIG. 24 is an explanatory view which explains the key generation processing of the conventional encryption processing system,

FIG. 25 is an explanatory view which explains the encryption processing of the conventional encryption processing system, and

FIG. 26 is an explanatory view which explains the decoding processing of the conventional encryption processing system.

### DETAILED DESCRIPTIONS

One embodiment of the encryption processing apparatus, the encryption processing unit control apparatus, the encryption processing unit, and the computer program according to the present invention will be explained hereinafter in detail while referring to the accompanying drawings.

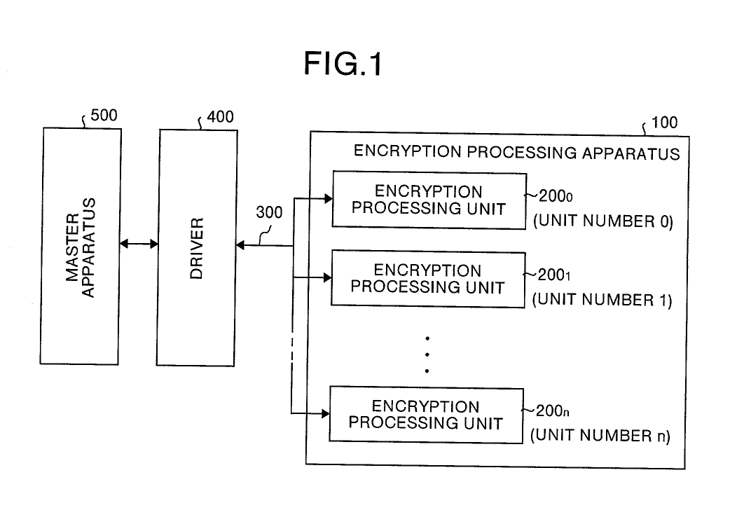

FIG. 1 is a block diagram which shows the configuration of one embodiment of the present invention. FIG. 1 shows an encryption processing system which consists of an encryption processing apparatus 100, a PCI bus 300, a driver 400 and a master apparatus 500. The encryption processing apparatus 100 mounts thereon n encryption processing units 200₀ to 200ₙ the security of which is protected. The encryption processing apparatus 100 encrypts a plain text input from the outside of the system to a cipher text, decodes the cipher text, and generates a key used for encryption and decoding.

The driver 400 controls the driving of the encryption processing units 200₀ to 200ₙ through the PCI bus 300 in accordance with an instruction from the master apparatus 500. The master apparatus 500 is a computer apparatus which executes an application program for encryption and decoding and which issues various instructions related to the registration, deletion, encryption and decoding of a key and the like to the driver 400.

Each of the encryption processing units 200₀ to 200ₙ has a function of generating a key used for encryption and decoding, a function of issuing a key ID of identifying the key, and a function of encrypting a plain text to a cipher text using the key according to an encryption algorithm, a function of decoding the cipher text using the key under the control of the driver 400. Besides, each encryption processing unit has a function of sharing the key among the other encryption processing units, a function of keeping the key consistent with the other keys and the like. The key generated by the encryption processing unit 200₀ is distributed to the encryption processing units 200₁ to 200ₙ.

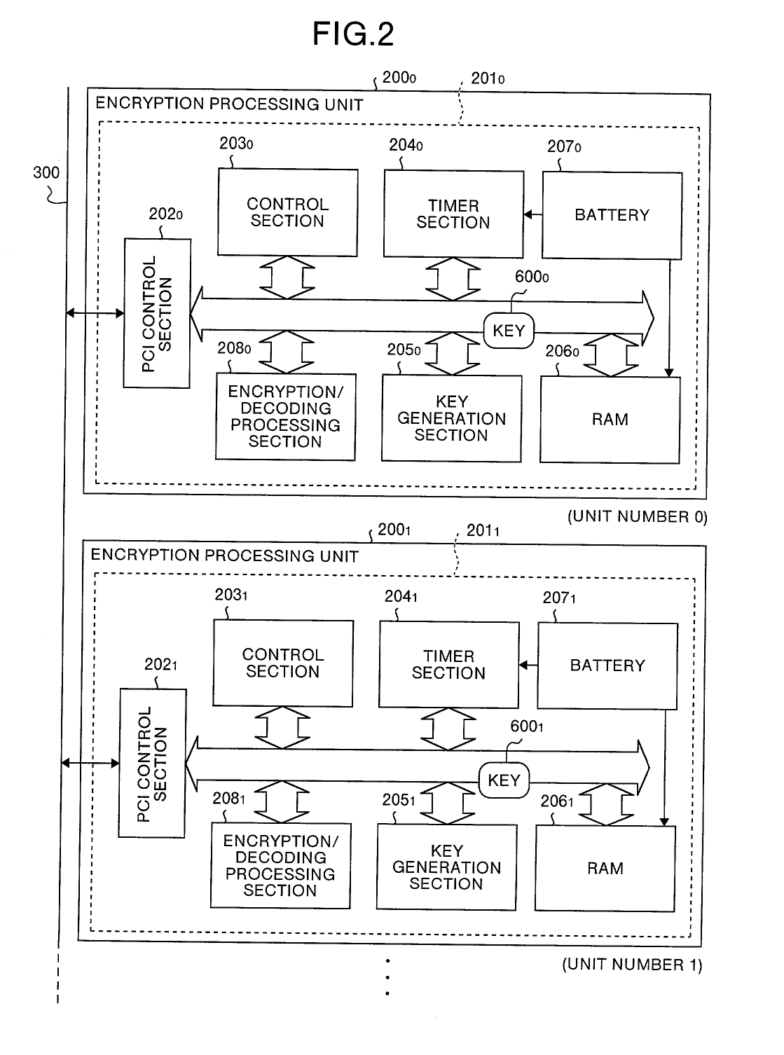

FIG. 2 is a block diagram which shows the configurations of the encryption processing units 200₀ and 200ₙ shown in FIG. 1. In FIG. 2, constituent elements corresponding to those shown in FIG. 1 are denoted by the same reference symbols as those in FIG. 1. In the encryption processing unit 200₀ shown in FIG. 2, a security guard 201₀ has a function of detecting an external attack to the encryption processing unit 200₀ and a function of forcedly deleting the key.

A PCI control section 202₀ controls the PCI bus 300 which is a communication interface between the driver 400 (see FIG. 1) and the encryption processing unit 200₀. A control section 203₀ consists of an MPU which execute a program and controls the respective sections, an ROM which serves as a storage region, a RAM and the like. The detail of this control section 203₀ will be explained later.

A timer section 204₀ is a real-time clock which outputs time information to a key generation section 205₀ if necessary. The key generation section 205₀ generates a unique key 600₀ using random numbers, time information, an accumulation timer or the like. In addition, the key generation section 205₀ issues a key ID identifying the key 600₀ and transmits the key ID to the driver 400.

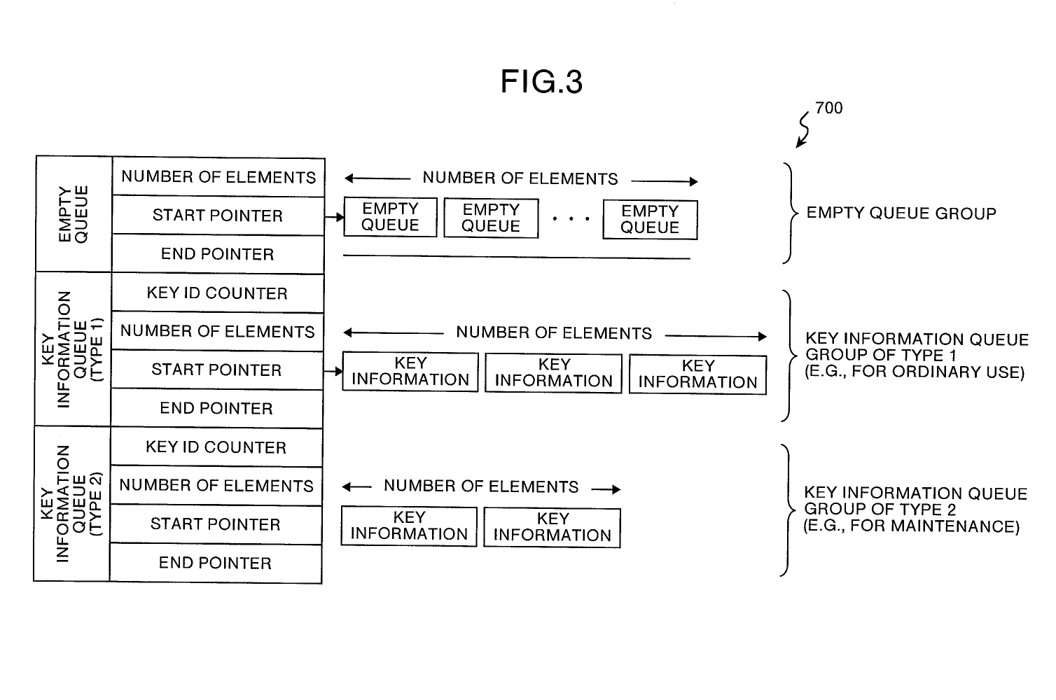

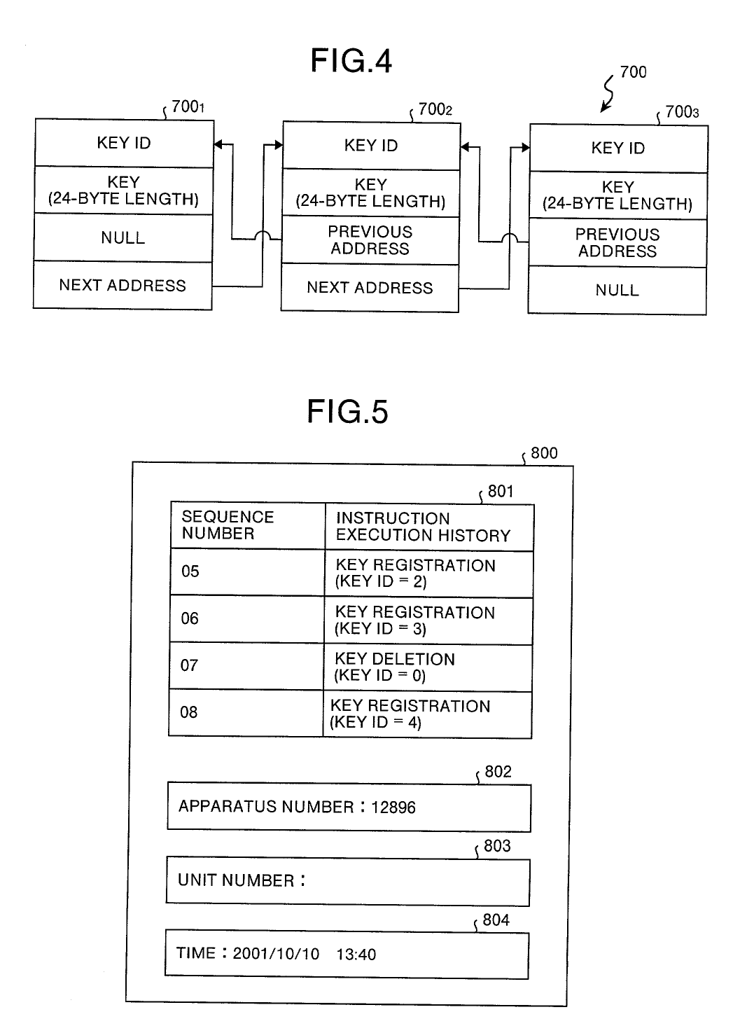

The RAM 206₀ stores a key management table 700 shown in FIGS. 3 and 4. In this key management table 700, the generated key is registered while making the key correspond to the key ID. Specifically, key information 700₁ to 700₃ shown in FIG. 4, for example, are registered in the key management table 700. The key information 700₁ to 700₃ constitute a key information queue group shown in FIG. 3 by address linkage. Each key information queue consists of information on the key ID, a key (24 bytes), NULL, next address and previous address.

Further, if no key information is registered in the key management table 700, an empty queue group exists. When the key and the key ID are registered, they are registered in a certain empty queue in the empty queue group as key information.

It should be noted herein that the key ID is transmitted from the encryption processing unit 200₀ to the master apparatus 500 and that the key 600₀ itself is not transmitted. As will be explained later, an encrypted key obtained by encrypting the key 600₀ is transmitted from the encryption processing unit 200₀ to the driver 400. As can be seen, in one embodiment of the present invention, as in the instance of the conventional encryption processing system explained above, the generation and storage of the key are closed in the encryption processing unit 200₀ to prevent the key from being leaked to the outside of the system, thereby maintaining high security.

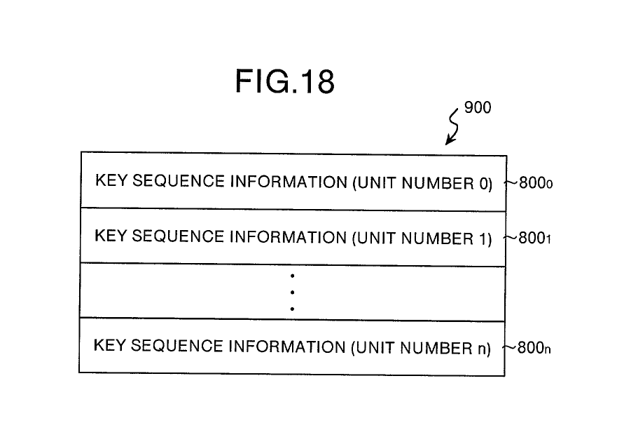

Furthermore, the RAM 206₀ stores key sequence information 800₀ (see FIG. 18) which the same in format as the key sequence information 800 shown in FIG. 5. This key sequence information 800 is information on the history of a sequence related to the execution of an instruction to register or delete the key. The key sequence information 800 consists of sequence history information 801, an apparatus number 802, a unit number 803 and time information 804.

The sequence history information 801 consists of a sequence number and a history (registration or deletion of the key and key ID) incremented by one when the instruction is executed and includes a maximum of information on four generations. The apparatus number 802 is a number identifying the encryption processing apparatus 100 (see FIG. 1) on which the encryption processing unit is mounted. The unit number 803 is a number identifying the encryption processing unit. The time information 804 indicates time at which the instruction is executed.

Referring back to FIG. 2, a battery 207₀ is the backup power supply of the timer section 204₀ and the RAM 206₀. An encryption/decoding processing section 208₀ has a function of encrypting a plain text to a cipher text using the key corresponding to the key ID and a function of decoding the cipher text using the key in accordance with an external instruction and the key ID. The encryption/decoding processing section 208₀ has also a function of encrypting the key generated by the key generation section 205₀.

The encryption processing unit 200₁ is the same in configuration and function as the encryption processing unit 200₀ explained above. Namely, the encryption processing unit 200₁ consists of a security guard 201₁, a PCI control section 202₁, a control section 203₁, a timer section 204₁, a key generation section 205₁ which generates a key 600₁, a RAM 206₁, a battery 207₁, and an encryption/decoding processing section 208₁. The encryption/decoding processing section 208₁ has also a function of decoding an encrypted key obtained by encrypting the key 600₀.

The other encryption processing units (200₂ (not shown) to 200ₙ) are the same in configuration and function as the above-explained encryption processing units 200₀ and 200₁.

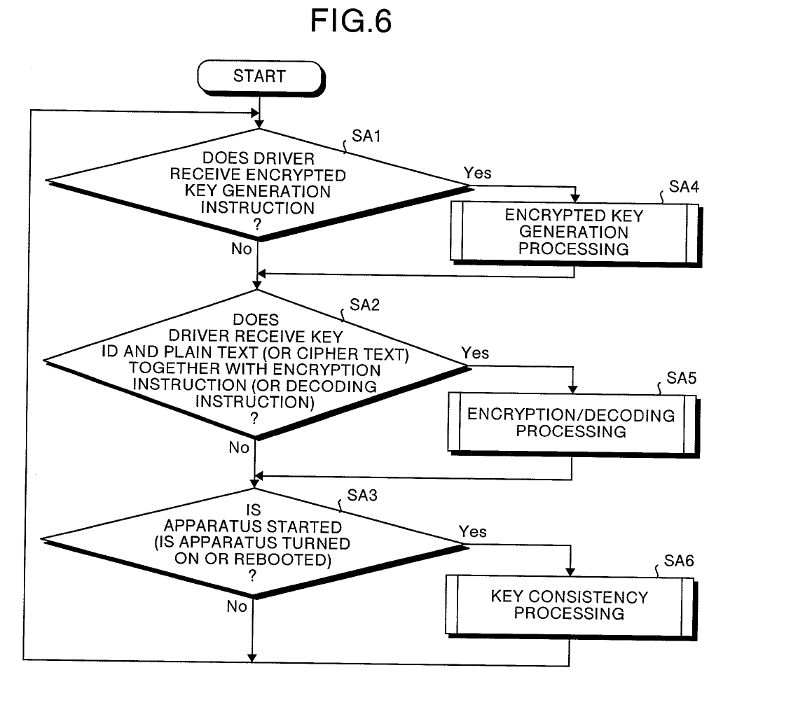

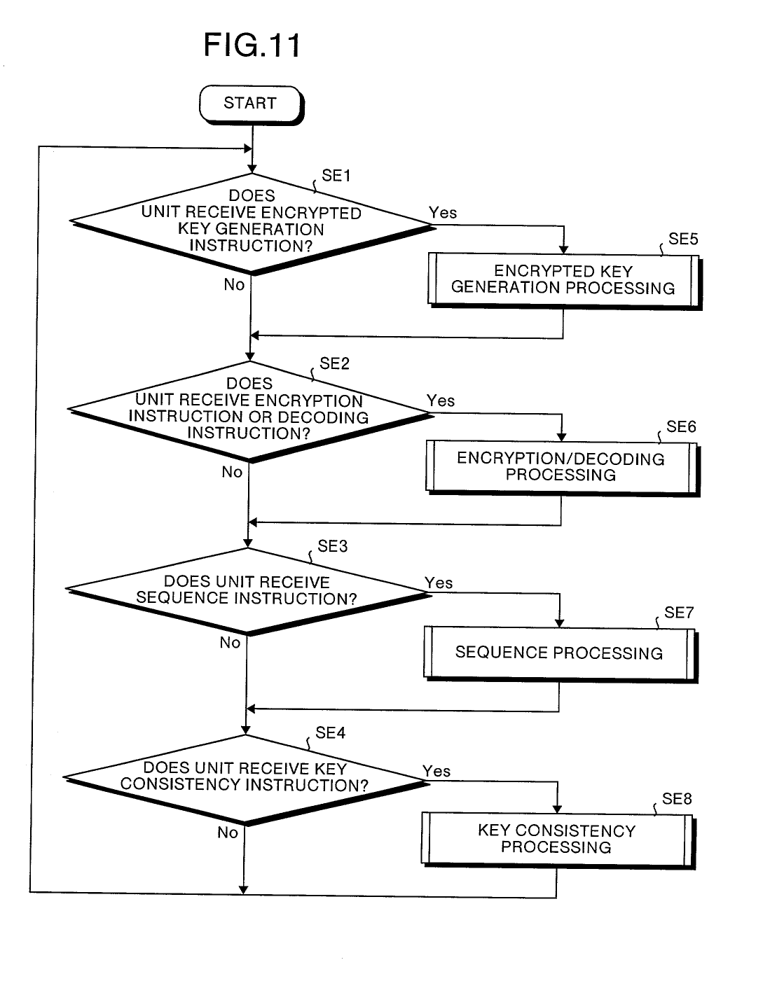

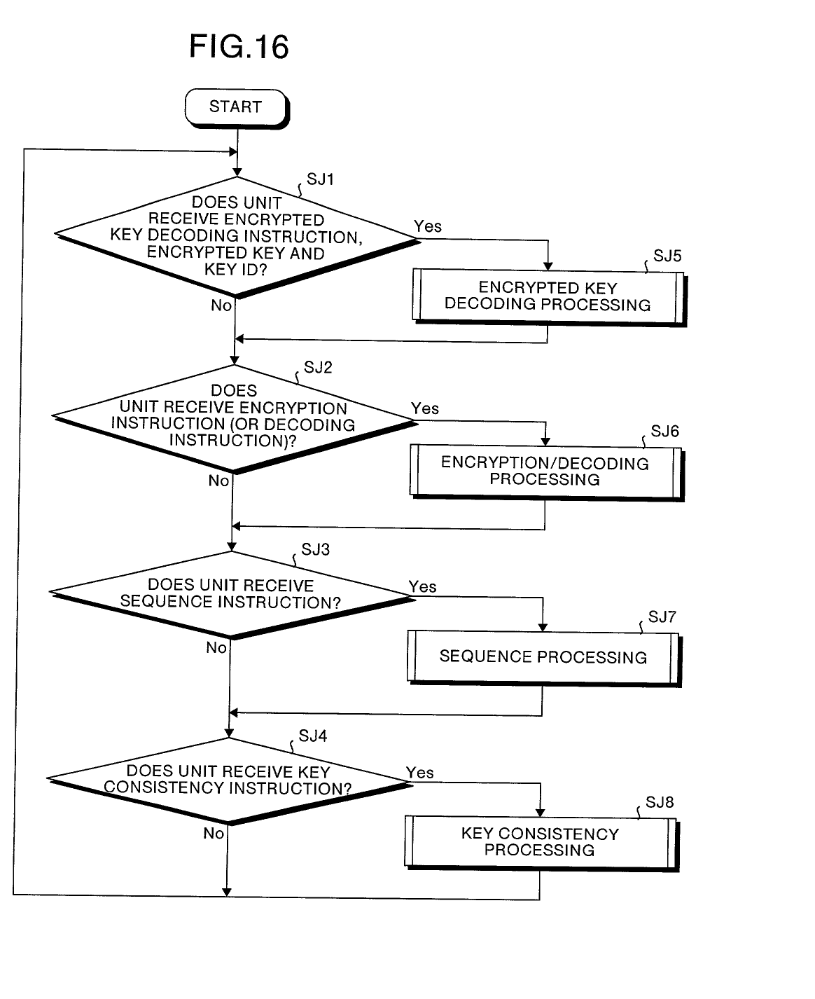

The operation of one embodiment will next be explained with reference to flow charts shown in FIGS. 6 to 17 and FIGS. 18 to 20. FIG. 6 is a flow chart which explains the operation of the driver 400 shown in FIG. 1. FIG. 11 is a flow chart which explains the operation of the encryption processing unit 200₀ shown in FIG. 1. FIG. 16 is a flow chart which explains the operations of the encryption processing units 200₁ to 200ₙ shown in FIG. 1.

At step SA1 shown in FIG. 6, the driver 400 determines whether or not the driver 400 receives an encrypted key generation instruction from the master apparatus 500. It is assumed herein that the determination result of the step SA1 is “No”. This encrypted key generation instruction is an instruction allowing the encryption processing unit 2000 to execute the generation of a key and the encryption of the key generated.

At step SA2, the driver 400 determines whether or not the driver 400 receives a key ID and a plain text (or a cipher text) together with an encryption instruction (or a decoding instruction) from the master apparatus 500. It is assumed herein that the determination result of the step SA2 is “No”. The encryption instruction is an instruction allowing one of the encryption processing units 200₀ to 200ₙ which has a free space for a processing, to execute the encryption of the plain text. The decoding instruction is an instruction allowing one of the encryption processing units 200₀ to 200ₙ which has a free space for a processing, to execute the decoding of the cipher text.

At step SA3, the driver 400 determines whether or not the encryption processing system is started by turning on or rebooting the system. It is assumed herein that the determination result of the step SA3 is “No”. Thereafter, the driver 400 repeats the determinations of the steps SA1 to SA3.

Meanwhile, at step SE1 shown in FIG. 11, the control section 2030 (see FIG. 2) of the encryption processing unit 200₀ determines whether or not the unit 200₀ receives the encrypted key generation instruction from the driver 400. It is assumed herein that the determination result of the step SE1 is “No”. At step SE2, the control section 203₀ determines whether or not the unit 200₀ receives the encryption instruction or the decoding instruction from the driver 400. It is assumed herein that the determination result of the step SE2 is “No”.

At step SE3, the control section 203₀ determines whether or not the unit 200₀ receives a sequence instruction to be explained later from the driver 400. It is assumed herein that the determination result of the step SE3 is “No”. At step SE4, the control section 203₀ determines whether or not the unit 200₀ receives a key consistency instruction to be explained later from the driver 400. It is assumed herein that the determination result of the step SE4 is “No”. Thereafter, the control section 203₀ repeats the determinations of the steps SE1 to SE4.

Further, at step SJ1 shown in FIG. 16, the control section 203₁ (see FIG. 2) determines whether or not the encryption processing unit 200₁ receives an encrypted key decoding instruction and an encrypted key from the driver 400. It is assumed herein that the determination result of the step SJ1 is “No”. The encrypted key decoding instruction is an instruction to decode the encrypted key generated by the encryption processing unit 200₀ and delivered to the encryption processing unit 200₁ through the driver 400 in the encryption processing unit 200₁.

At step SJ2, the control section 203₁ determines whether or not the unit 200₁ receives an encryption instruction (or a decoding instruction) from the driver 400. It is assumed herein that the determination result of the step SJ2 is “No”. At step SJ3, the control section 203₁ determines whether or not the unit 200₁ receives a sequence instruction from the driver 400. It is assumed herein that the determination result of the step SJ3 is “No”.

At step SJ4, the control section 203₁ determines whether or not the unit 200₁ receives a key consistency instruction from the driver 400. It is assumed herein that this determination result is “No”. Thereafter, the control section 203₁ repeats the determinations of the steps SJ1 to SJ4. It is noted that the other encryption processing units 200₂ (not shown) to 200ₙ execute their respective processings in accordance with the flow chart shown in FIG. 16 as in the instance of the encryption processing unit 200₁.

If the driver 400 receives the encrypted key generation instruction issued from the master apparatus 500, the driver 400 determines “Yes” at the step SA1 shown in FIG. 6. At step SA4, the driver 400 executes an encrypted key generation processing.

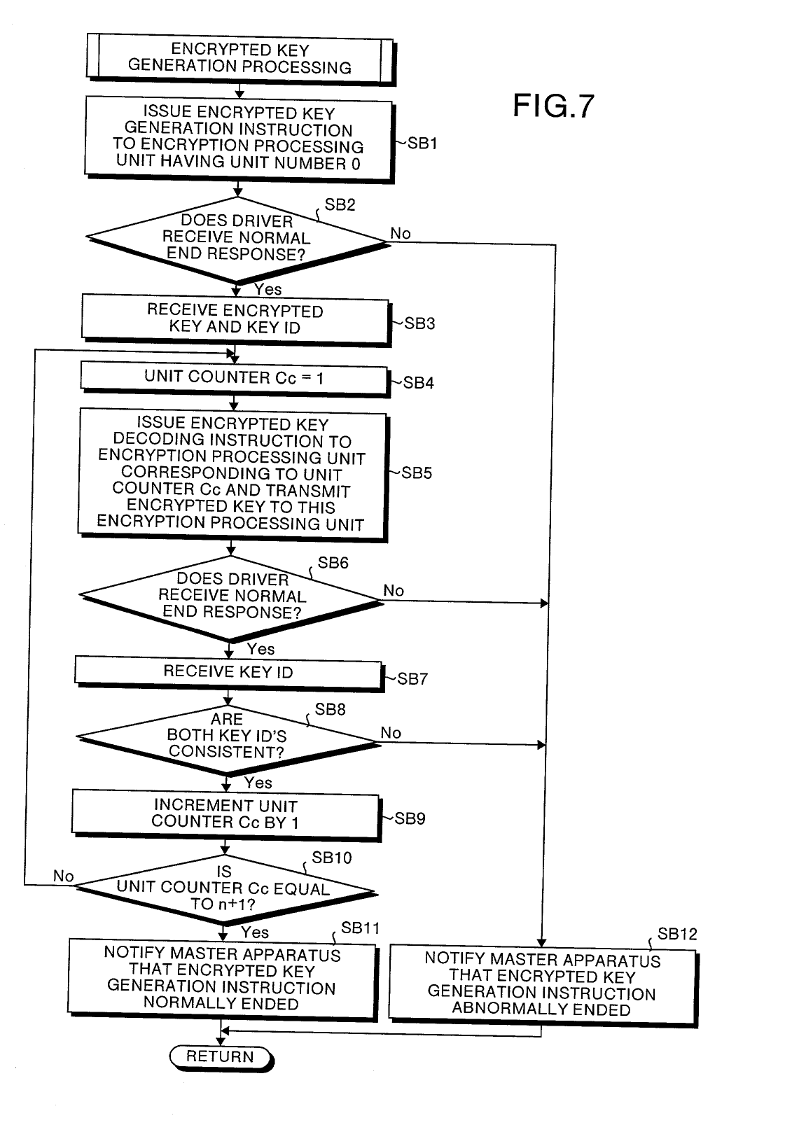

Specifically, at step SB1 shown in FIG. 7, the driver 400 issues an encrypted key generation instruction to the encryption processing unit 200₀ having a unit number 0. As a result, the control section 203₀ (see FIG. 2) of the encryption processing unit 200₀ determines “Yes” at the step SE1 shown in FIG. 1. At step SE5, an encrypted key generation processing is carried out.

In one embodiment of the present invention, the encrypted key generation processing carried out by the encryption processing unit 200₀ corresponding to the unit number 0 has been explained. Since the other encryption processing units have the same configurations and functions as those of the unit 200₀, the other encryption processing units can execute encrypted key generation processings, respectively.

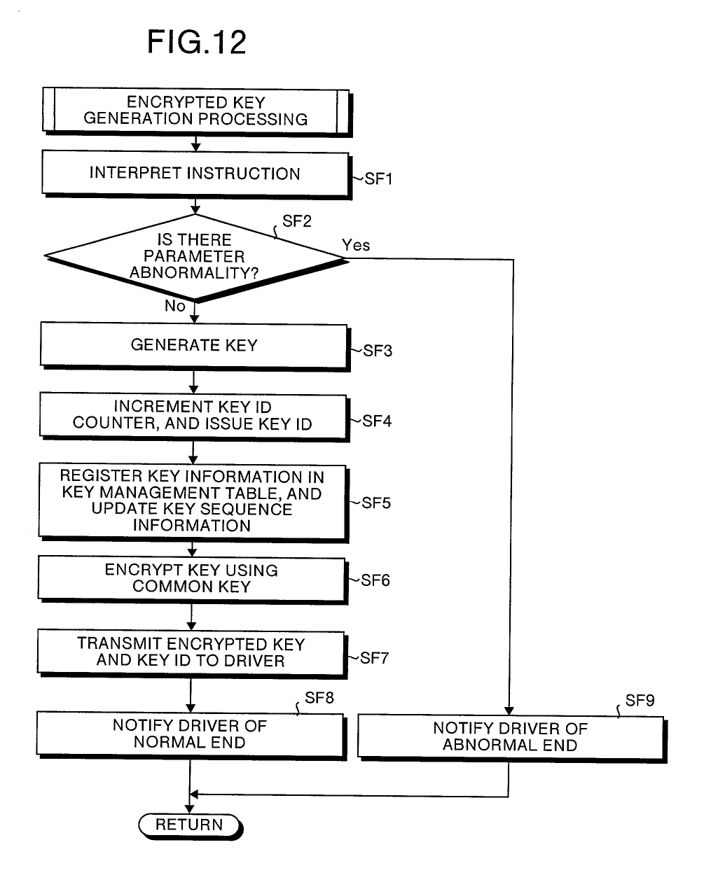

Specifically, at step SF1 shown in FIG. 12, the control section 203₀ interprets the received instruction and recognizes that the instruction is an encrypted key generation instruction. At step SF2, the control section 203₀ determines whether or not there is an abnormality in an encrypted key generation instruction parameter. It is assumed herein that the determination result of the step SF2 is “No”.

At step SF3, the key generation section 205₀ generates a key based on the time information, random numbers, the accumulation timer or the like of the timer section 204₀. At step SF4, the key generation section 205₀ generates a unique key ID identifying the generated key. This key ID is issued by incrementing a key ID counter (not shown) every time a key is generated in the key generation section 200₀ or an encrypted key received from the other encryption processing unit is decoded.

At step SF5, the control section 203₀ registers the key generated at the step SF3, the key ID issued at the step SF4 and an address in the key management table 700 shown in FIG. 4 as, for example, key information 700₃.

The control section 203₀ next updates the key sequence information 800₀ (see FIG. 18) which is the same in format as the key sequence information 800 shown in FIG. 5. Specifically, the control section 203₀ adds a sequence number and a history (key registration (key ID)) incremented by one to sequence history information (which is sequence history information 801: see FIG. 5) and updates time information (which is time information 804: see FIG. 5).

Referring back to FIG. 12, at step SF6, the encryption/decoding processing section 208₀ encrypts the key generated at the step SF3 using a common key. At step SF7, the control section 203₀ transmits the encrypted key encrypted at the step SF6 and the key ID generated at the step SF4 to the driver 400.

At step SF8, the control section 203₀ notifies the driver 400 of normal end. If the determination result of the step SF2 is “Yes”, the control section 203₀ notifies the driver 400 of abnormal end at step SF9.

Referring back to FIG. 7, the driver 400 determines whether or not the driver 400 receives a normal end response from the encryption unit 200₀ at step SB2. It is assumed herein that the determination result of the step SB2 is “Yes”. At step SB3, the driver 400 receives the encrypted key and the key ID from the encryption processing unit 2000.

At step SB4, the driver 400 assigns 1 to a unit counter Cc. This unit counter Cc corresponds to the encryption processing unit to which an encrypted key decoding instruction is issued. For example, the unit counter Cc=0 corresponds to the encryption processing unit 200₀ and the unit counter Cc=n corresponds to the encryption processing unit 200ₙ.

At step SB5, the driver 400 issues an encrypted key decoding instruction to the encryption processing unit 200₁ corresponding to the unit counter Cc (=1) and transmits an encrypted key to the encryption processing unit 200₁.

When the encryption processing unit 200₁ receives the encrypted key decoding instruction and the encrypted key, the control section 203₁ (see FIG. 2) determines “Yes” at the step SJ1 shown in FIG. 16. At step SJ5, an encrypted key decoding processing is executed.

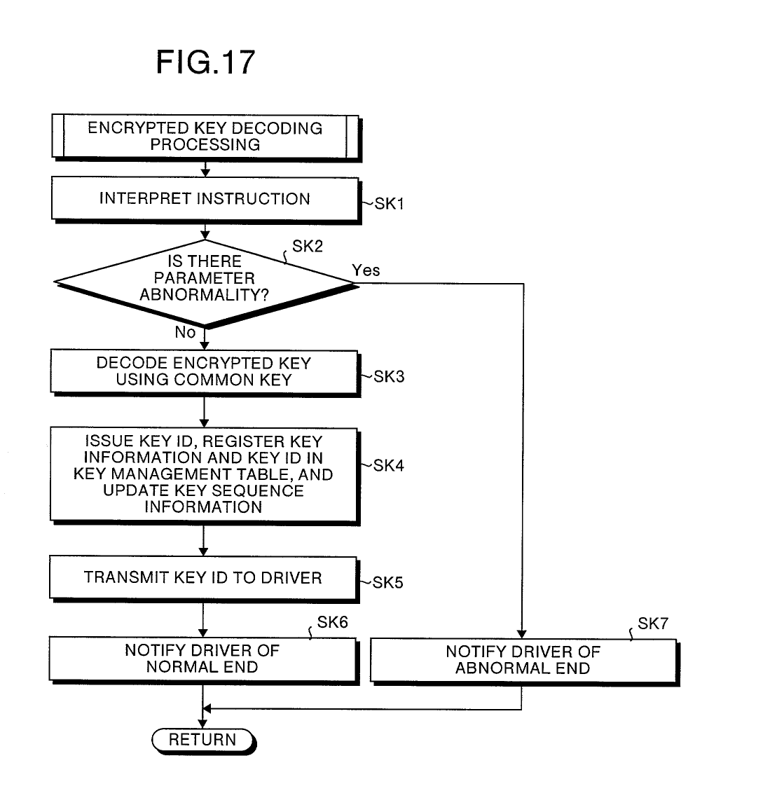

Specifically, at step SK1 shown in FIG. 17, the control section 203₁ interprets the received instruction and recognizes that the instruction is an encrypted key decoding instruction. At step SK2, the control section 203₁ determines whether or not there is an abnormality in an encrypted key decoding instruction parameter. It is assumed herein that the determination result of the step SK2 is “No”.

At step SK3, the encryption/decoding processing section 208₁ decodes the encrypted key using a common key. At step SK4, the control section 203₁ registers key information (decoded key, received key ID and address) in the key management table (not shown). The key ID is issued by incrementing the key ID counter (not shown) as in the instance of the processing performed to generate the key in the encryption processing unit 200₀ (step SF4: see FIG. 12).

The control section 203₁ updates the key sequence information 800₁ (see FIG. 18) which is the same in format as the key sequence information 800 shown in FIG. 5. Specifically, the control section 203₁ adds a sequence number and a history (key registration (key ID)) incremented by one to the sequence history information (which is sequence history information 801: see FIG. 5) and updates the time information (which is time information 804: see FIG. 5). At step SK5, the control section 203₁ transmits the key ID corresponding to the decoded key to the driver 400.

At step SK6, the control section 203₁ notifies the driver 400 of normal end. If the determination result of the step SK2 is “Yes”, the control section 203₁ notifies the driver 400 of abnormal end at step SK7.

Referring back to FIG. 7, at step SB6, the driver 400 determines whether or not there is a normal end response from the encryption processing unit (which is the encryption processing unit 200₁ in this instance) to which the encrypted key decoding instruction is issued. It is assumed herein that the determination result of the step SB6 is “Yes”. At step SB7, the driver 400 receives the key ID from the encryption processing unit (which is the encryption processing unit 200₁ in this instance).

At step SB8, the driver 400 determines whether or not the key ID transmitted at the step SB5 is consistent with the key ID received at the step SB7. It is assumed herein that the determination result of the step SB8 is “Yes”. If the both key ID's are consistent with each other, it means that the same key as the key generated in the encryption processing unit 200₀ is normally delivered to the encryption processing unit 200₁.

At step SB9, the driver 400 increments the unit counter Cc by one (1+1=2). At step SB10, the driver 400 determines whether or not the unit counter Cc (=2) is n (where n is the total number of the encryption processing units)+1. It is assumed herein that the determination result of the step SB9 is “No”.

Thereafter, the steps SB4 to SB10 are repeated, whereby a series of processings of the issuance of the encrypted key decoding instruction, the decoding of the encrypted key and the registration of the key in the order of encryption processing unit 200₂ (not shown) to encryption processing unit 200₃ (not shown) to . . . to encryption processing unit 200ₙ. As a result, the key generated in the encryption processing unit 200₀ is sequentially delivered to the encryption processing units 200₂ (not shown) to 200ₙ.

As can be understood from the above, the key generated in one encryption processing unit never fails to exist in all the other encryption processing units. That is, all the encryption processing units hold the same key. In addition, the key ID is issued by incrementing the key ID counter every time the key is registered in each encryption processing unit. Therefore, the key ID corresponding to the same key is theoretically common to all the encryption processing units.

If the determination result of the step SB10 is “Yes”, the driver 400 notifies the master apparatus 500 that the encrypted key generation instruction normally ended at step SB11. If the determination result of the step SB2, SB6 or SB8 is “No”, the driver 400 notifies the master apparatus 500 that the encrypted key generation instruction abnormally ended at step SB12. Further, if the same key is sequentially deleted from the encryption processing units 200₀ to 200ₙ, a key deletion instruction is issued.

If the driver 400 receives the key ID together with the encryption instruction (plain text) or the decoding instruction (cipher text) issued from the master apparatus 500, the driver 400 determines “Yes” at the step SA2 shown in FIG. 6. At step SA5, an encryption/decoding processing is executed.

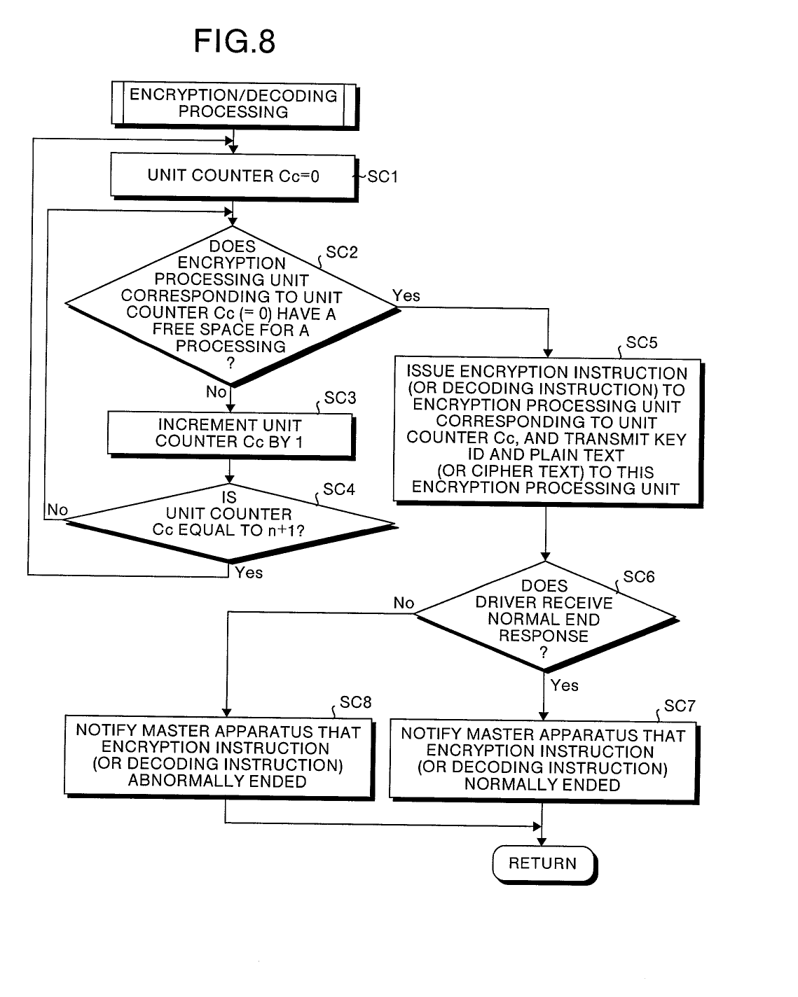

Specifically, at step SC1 shown in FIG. 8, the driver 400 assigns 0 to the unit counter Cc. At step SC2, the driver 400 determines whether or not the encryption processing unit corresponding to the unit counter Cc (=0) (which is the encryption processing unit 200₀ in this instance) has a free space for a processing.

When the encryption processing unit 200₀ is executing a different encryption processing, for example, the driver 400 determines “No” at the step SC2 and SC3, increments the unit counter Cc by one (0+1=1). At step SC4, the driver 400 determines whether or not the unit counter Cc is n+1. It is assumed herein that the determination result of the step SC4 is “No”.

At the step SC2, the driver 400 determines whether or not the encryption processing unit corresponding to the unit counter Cc (=1) (which is the encryption processing unit 200₁ in this instance) has a free space for a processing. If the encryption processing unit 200₁ does not execute any processing, the driver 400 determines “Yes” at the step SC2.

At step SC5, the driver 400 issues an encryption instruction (or a decoding instruction) to the encryption processing unit corresponding to the unit counter Cc (which is the encryption processing unit 200₁ in this instance) and transmits a key ID and a plain text (or a cipher text) to the encryption processing unit.

If the encryption processing unit 200₁ receives the encryption instruction (or the decoding instruction), the key ID and the plain text (or the cipher text), the control section 203₁ (see FIG. 2) of the encryption processing unit 200₁ determines “Yes” at the step SJ2 shown in FIG. 16. At step SJ6, an encryption/decoding processing is executed.

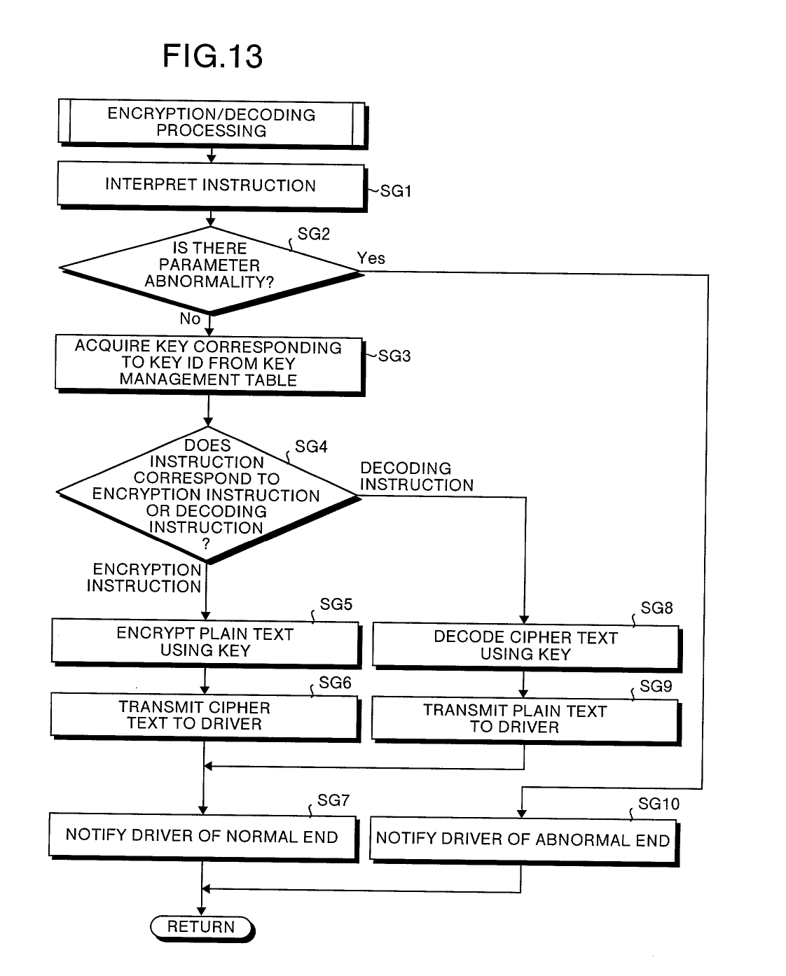

Specifically, at step SG1 shown in FIG. 13, the control section 203₁ interprets the received instruction and recognizes that the instruction is an encryption instruction (or a decoding instruction).

At step SG2, the control section 203₁ determines whether or not there is an abnormality in an encryption instruction parameter (or a decoding instruction parameter) It is assumed herein that the determination result of the step SG2 is “Yes”.

At step SG3, the control section 203₁ acquires a key corresponding to the key ID from the key management table 700 (see FIG. 4) in the RAM 206₁. At step SG4, the control section 203₁ determines whether the instruction is an encryption instruction or a decoding instruction.

If the instruction is an encryption instruction, the control section 203₁ encrypts the plain text to a cipher text using the key acquired at the step SG3, at step SG5. At step SG6, the control section 203₁ transmits the cipher text to the driver 400. At step SG7, the control section 203₁ notifies the driver 400 of normal end.

On the other hand, at step SG8, if the instruction is a decoding instruction, the control section 203₁ decodes the cipher text to a plain text using the key acquired at the step SG3. At step SG9, the control section 2031 transmits the pain text to the driver 400. At the step SG7, the control section 203₁ notifies the driver 400 of normal end.

Referring back to FIG. 8, at step SC6, the driver 400 determines whether or not the driver 400 receives a normal end response from the encryption processing unit 200₁. It is assumed herein that the determination result of the step SC6 is “Yes”. At step SC7, the driver 400 notifies the master apparatus 500 that the encryption instruction (or the decoding instruction) normally ended.

On the other hand, if the determination result of the step SG2 shown in FIG. 13 is “Yes”, the control section 2031 notifies the driver 400 of abnormal end at step SG10. In response to the notification, the driver 400 determines “No” at the step SC6 shown in FIG. 8. At step SC8, the driver 400 notifies the master driver 500 that the encryption instruction (or the decoding instruction) abnormally ended.

Further, if the encryption processing system shown in FIG. 1 is started by turning on or rebooting the system, the driver 400 determines “Yes” at the step SA3 shown in FIG. 6. At step SA6, the driver 400 executes a key consistency processing to keep keys consistent with one another among the encryption processing units 200₀ to 200ₙ.

If a power failure occurs to any one of the encryption processing units 200₀ to 200ₙ while the units 200₀ to 200ₙ are executing processings of registering or deleting the same key, respectively, then the encryption processing unit cannot register or delete the key.

In this instance, the difference of the keys held is generated between the encryption processing unit to which the power failure occurs and the other encryption processing units. The key consistency processing to be explained later is intended to correct the difference of the keys held and to make the keys held by the encryption processing units consistent with one another.

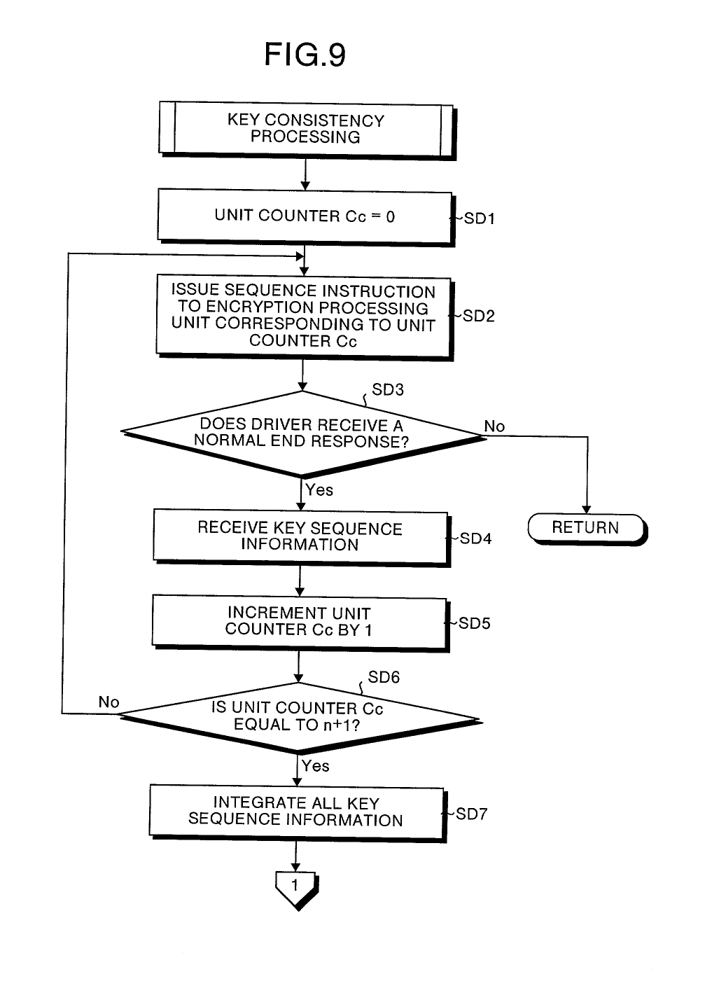

Specifically, at step SD1 shown in FIG. 9, the driver 400 assigns 0 to the unit counter Cc. At step SD2, the driver 400 issues a sequence instruction to the encryption processing unit corresponding to the unit counter Cc (=0) (which is the encryption processing unit 200₀ in this instance).

If the encryption processing unit 200₀ receives the sequence instruction, the control section 203₀ of the encryption processing unit 200₀ determines “Yes” at the step SE3 shown in FIG. 11. At step SE7, a sequence processing which transmits key sequence information to the driver 400 is executed.

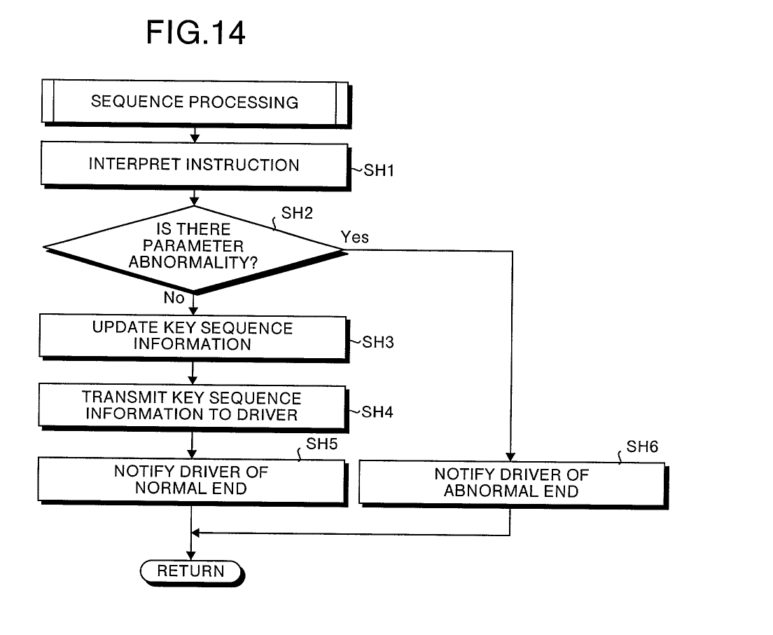

Specifically, at step SH1 shown in FIG. 14, the control section 203₀ interprets the received instruction and recognizes that the instruction is a sequence instruction. At step SH2, the control section 203₀ determines whether or not there is an abnormality in a sequence instruction parameter. It is assumed herein that the determination result of the step SH2 is “No”.

At step SH3, the control section 203₀ updates the time information (which is the time information 804: see FIG. 5) in the key sequence information 800₀ (see FIG. 18). At step SH4, the control section 203₀ transmits the key sequence information 800₀ to the driver 400. At step SH5, the control section 203₀ notifies the driver 400 of normal end. If the determination result of the step SH2 is “Yes”, the control section 203₀ notifies the driver 400 of abnormal end at step SH6.

Referring back to FIG. 9, at step SD3, the driver 400 determines whether or not the driver 400 receives a normal end response from the encryption processing unit 200₀. It is assumed herein that the determination result of the step SD3 is “Yes”. At step SD4, the driver 400 receives key sequence information 8000 (see FIG. 18) from the encryption processing unit 200₀.

At step SD5, the driver 400 increments the unit counter Cc by one (0+1=1). At step SD6, the driver 400 determines whether or not the unit counter Cc is n+1. It is assumed herein that the determination result of the step SD6 is “No”.

Returning to the step SD2, the driver 400 issues a sequence instruction to the next encryption processing unit corresponding to the unit counter Cc (=1) (which is the encryption processing unit 200₁ in this instance).

When the encryption processing unit 200₁ receives the sequence instruction, the control section 203₁ of the encryption processing unit 200₁ determines “Yes” at the step SJ3 shown in FIG. 16. At step SJ7, a sequence processing transmitting the key sequence information to the driver 400 is executed.

Specifically, at step SH1 shown in FIG. 14, the control section 203₁ interprets the received instruction and recognizes that the instruction is a sequence instruction. At step SH2, the control section 203₁ determines whether or not there is an abnormality in a sequence instruction parameter. It is assumed herein that the determination result of the step SH2 is “No”.

At step SH3, the control section 203₁ updates the time information (which is the time information 804: see FIG. 5) in the key sequence information 800₁ (see FIG. 18). At step SH4, the control section 203₁ transmits the key sequence information 800₁ to the driver 400. At step SH5, the control section 203₁ notifies the driver 400 of normal end.

Referring back to FIG. 9, at the step SD3, the driver 400 determines whether or not there is a normal end response from the encryption processing unit 200₁. It is assumed herein that the determination result of the step SD3 is “Yes”. At the step SD4, the driver 400 receives the key sequence information 800₁ (see FIG. 18) from the encryption processing unit 200₁.

At the step SD5, the driver 400 increments the unit counter Cc by one (1+1=2) At the step SD6, the driver 400 determines whether or not the unit counter Cc is n+1. It is assumed herein that the determination result of the step SD6 is “No”. Thereafter, the steps SD2 to SD6 are repeated, whereby the driver 400 sequentially receives the key sequence information 800₂ (not shown) to 800ₙ (see FIG. 18) from the encryption processing units 200₂ (not shown) to the encryption processing unit 200ₙ, respectively.

If the determination result of the step SD6 becomes “Yes”, at step SD7, the driver 400 integrates all the received key sequence information 800₀ to 800ₙ and generates integrated key sequence information 900 as shown in FIG. 18.

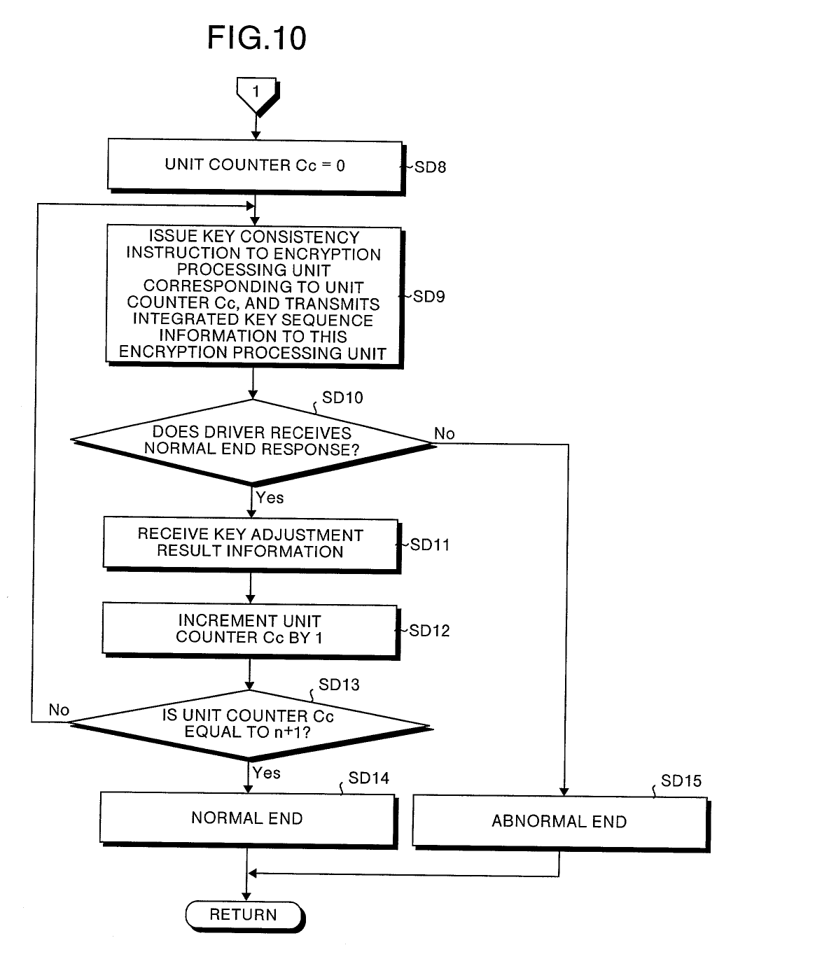

At step SD8 shown in FIG. 10, the driver 400 assigns 0 to the unit counter Cc. At step SD9, the driver 400 issues a key consistency instruction to the encryption processing unit corresponding to the unit counter Cc (=0) (which is the encryption processing unit 200₀ in this instance) and transmits the integrated key sequence information 900 (see FIG. 18) to the encryption processing unit.

When the encryption processing unit 200₀ receives the key matching instruction and the integrated key sequence information 900, the control section 203₀ of the encryption processing unit 200₀ determines “Yes” at the step SE4 shown in FIG. 11. At step SE8, a key consistency processing is executed.

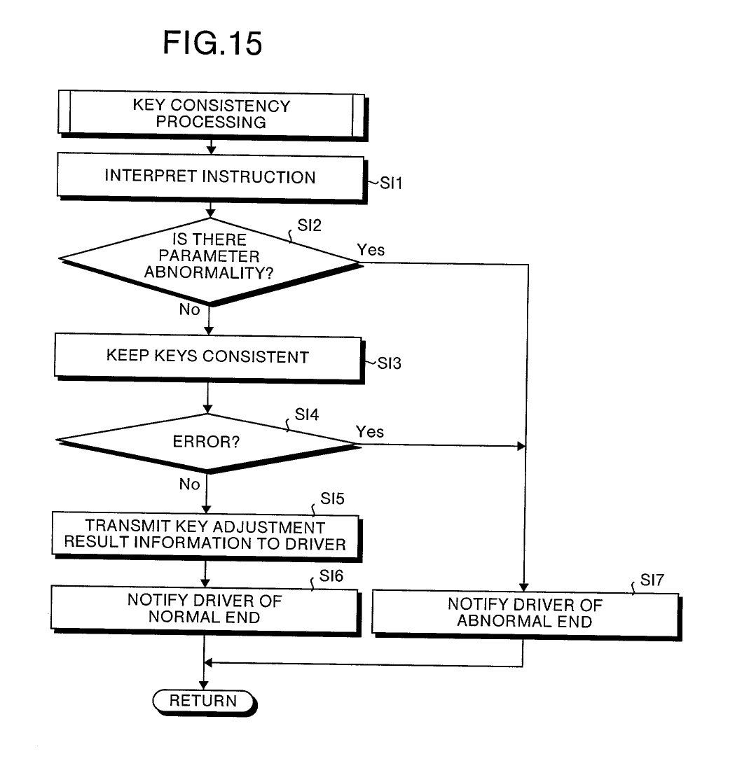

Specifically, at step SI1 shown in FIG. 15, the control section 2030 interprets the received instruction and recognizes that the instruction is a key consistency instruction. At step SI2, the control section 203₀ determines whether or not there is an abnormality in a key matching instruction parameter. It is assumed herein that the determination result of the step SI2 is “No”.

At step SI3, the control section 203₀ makes the keys consistent with one another based on the integrated key sequence information 900. Specifically, the control section 203₀ examines consistency as to “apparatus number” (apparatus number 802: see FIG. 5), “unit number” (unit number 803), “time information” (time information 804) and “sequence history information” (sequence history information 801) among the key sequence information 800₀ to 800ₙ in the integrated key sequence information 900 shown in FIG. 18.

As for the “apparatus number”, it is determined whether or not the apparatus numbers of the key sequence information 800₀ to 800ₙ are consistent with one another. If the apparatus numbers are consistent, it is determined that the consistency of “apparatus number” is satisfied. If not consistent, an error is determined.

As for the “unit number”, it is determined whether or not the unit numbers of the key sequence information 800₀ to 800ₙ overlap. If the unit numbers do not overlap, it is determined that the “unit numbers” are consistent. If the numbers overlap, an error is determined.

As for the “time information”, it is determined whether or not the fluctuation of the time information of the key sequence information 800₀ to 800ₙ is within a certain time (e.g., two minutes). If the fluctuation is within the certain time, it is determined that time information is consistent. If the fluctuation exceeds the certain time, an error is determined.

As for the “sequence history information”, it is determined whether or not the difference between the final sequence numbers thereof is within an allowable value (e.g., 1) and whether or not histories are consistent by comparing the key sequence information on the relevant unit (which is the key sequence information 800₀) with the other key sequence information (which is key sequence information 800₁ to 800ₙ in this instance).

If there is no difference in final sequence number and histories are consistent, then it is determined that the sequence history information is consistent. If the difference in final sequence number exceeds the allowable value and the history information is inconsistent, then an error is determined.

Further, the difference in final sequence number is within the allowable value, the information is adjusted so as to be consistent with the sequence information having the smallest number of keys held among the key sequence information 800₀ to 800ₙ.

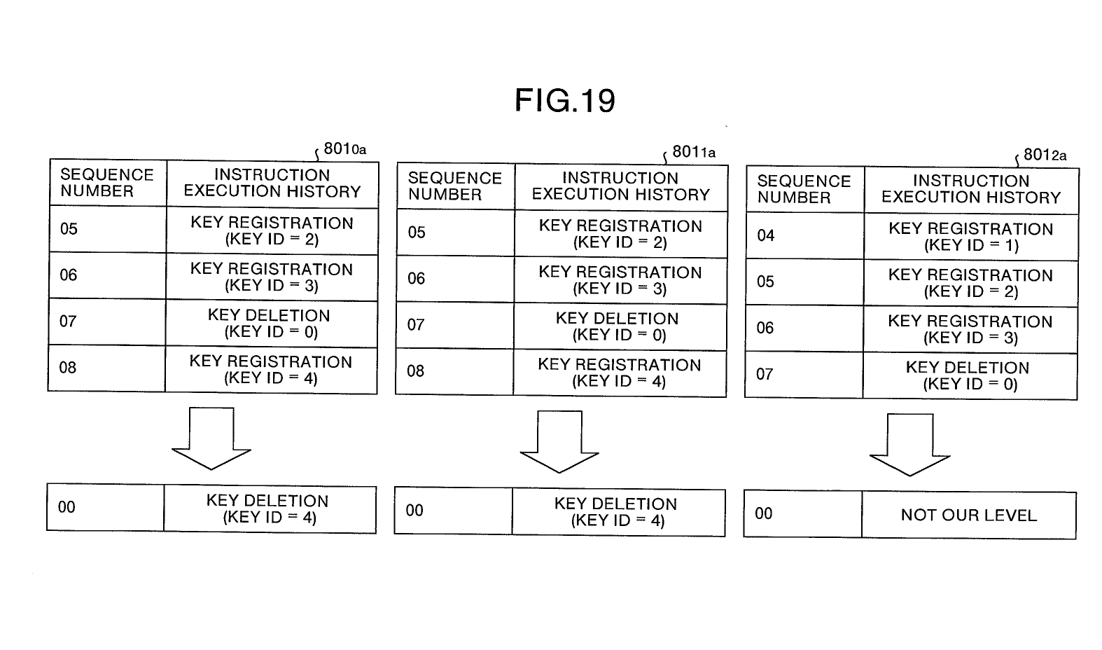

FIG. 19 shows the first example of the key consistency processing. In FIG. 19, sequence history information 801₀ₐ, 801₁ₐ and 801₂ₐ correspond to the key sequence information 801₀, 801₁ and 801ₙ (n=2) shown in FIG. 18, respectively.

With reference to the sequence history information 801₀ₐ, the difference between the final sequence number (=08) of the sequence history information 801₀ₐ and the final sequence number (=07) of the sequence history information 801₂ₐ is 1. It is noted that the difference between the final sequence number (=08) of the sequence history information 801₀ₐ and the final sequence number (=08) of the sequence history information 801₁ₐ is 0.

In this instance, the control section 203₀ sets the sequence number as 00 and deletes the key corresponding to the key ID=4 from the key management table. By doing so, the key sequence information 801₀ₐ is adjusted to be consistent with the key sequence information 801₂ₐ having the smallest number of held keys. It is noted that the control section 203₁ corresponding to the key history information 801₁ₐ executes the same key adjustment processing. In addition, the control section corresponding to the sequence history information 801₂ₐ updates the sequence number to 00 but does not execute a key adjustment processing.

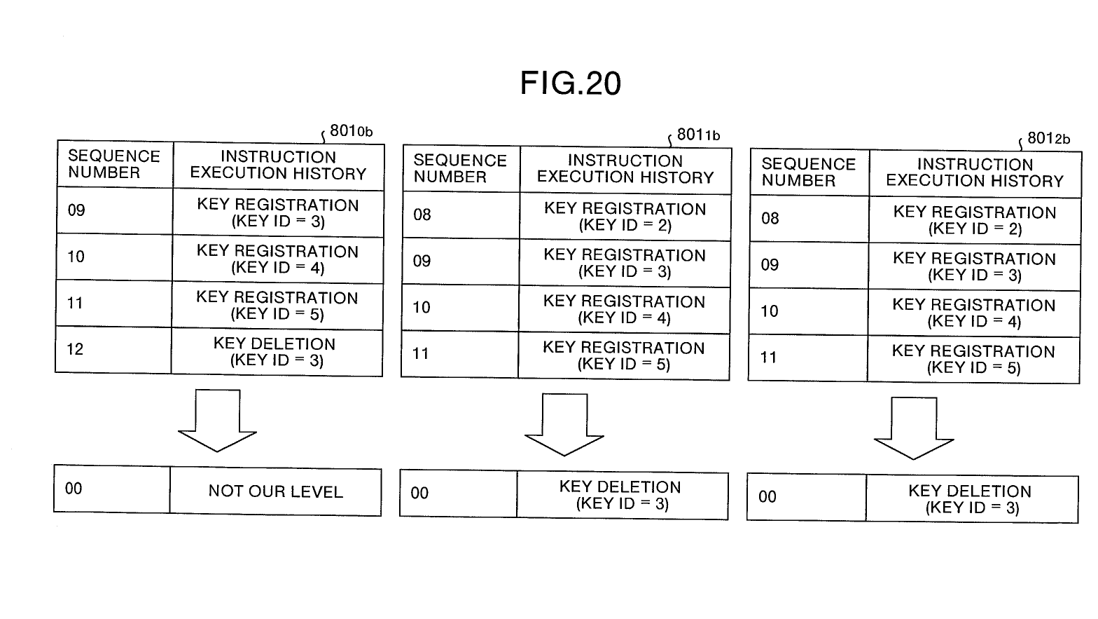

FIG. 20 shows the second example of the key consistency processing. In FIG. 20, sequence history information 801_{0b}, 801_{1b} and 801_{2b} correspond to the sequence history information in the key sequence information 800₀, 800₁ and 800ₙ (n=2) shown in FIG. 18, respectively.

With reference to the sequence history information 801_{0b}, the difference between the final sequence number (=12) of the sequence history information 801_{0b} and the final sequence number (=11) of the sequence history information 801_{1b} and the difference between the final sequence number (=12) of the sequence history information 801_{0b} and the final sequence number (=11) of the sequence history information 801_{2b} are 1, respectively.

In this instance, the instruction to the sequence number 12 is “delete key” and the control section 203₀ updates the sequence number to 00 but does not executes a key adjustment processing. It is noted that the control section 203₁ corresponding to the sequence history information 801_{1b} updates the sequence number to 00 and deletes the key corresponding to the key ID=3 from the key management table.

As a result, the key sequence information 801_{1b} is adjusted to be consistent with the key sequence information 801_{0b} having the smallest number of the held keys. In addition, the control section 203₂ corresponding to the sequence history information 801_{2b} executes the same key adjustment processing as that of the control section 203₁.

Referring back to FIG. 15, at step SI4, the control section 203₀ determines whether or not an error is determined (key adjustment cannot be made) at the step SI3. It is assumed herein that the determination result of the step SI4 is “No”. At step SI5, the control section 203₀ transmits key adjustment result information including information as to whether or not the key is deleted and the key ID corresponding to the deleted key, to the driver 400.

At step SI6, the control section 203₀ notifies the driver 400 of normal end. If the determination result of the step SI2 or SI4 is “Yes”, the control section 203₀ notifies the driver 400 of abnormal end at step SI7.

Referring back to FIG. 10, at step SD10, the driver 400 determines whether or not the driver 400 receives a normal end response from the encryption processing unit 200₀. It is assumed herein that the determination result of the step SD10 is “Yes”. At step SD11, the driver 400 receives key adjustment result information from the encryption processing unit 200₀.

At step SD12, the driver 400 increments the unit counter Cc by one (0+1=1). At step SD13, the driver 400 determines whether or not the unit counter Cc is n+1. It is assumed herein that the determination result of the step SD13 is “No”.

Returning to the step SD9, the driver 400 issues a key consistency instruction to the encryption processing unit corresponding to the unit counter Cc (=1) (which is the encryption processing unit 200₁ in this instance) and transmits integrated key sequence information 900 (see FIG. 18) to the encryption processing unit.

When the encryption processing unit 200₁ receives the key consistency instruction and the integrated key sequence information 900, the control section 203₁ of the encryption processing unit 200₁ determines “Yes” at the step SJ4 shown in FIG. 16. At step SJ8, a key consistency processing (see FIG. 15) is executed. Thereafter, the steps SD9 to SD13 shown in FIG. 10 are repeated, whereby the encryption processing units 200₂ (not shown) to 200ₙ execute key consistency processings, respectively.

If the determination result of the step SD13 becomes “Yes”, the driver 400 transmits the key adjustment result information to the master apparatus 500 at step SD14 and determines that the key adjustment processing normally ended. On the other hand, if the determination result of the step SD10 is “No”, the driver 400 determines that the key adjustment processing abnormally ended at step SD15. If the determination result of the step SE2 shown in FIG. 11 is “Yes”, the above-explained decoding/encryption processing (see FIG. 13) is executed at step SE6.

As explained so far, according to one embodiment of the present invention, the specific encryption processing unit 200₀ among a plurality of encryption processing units 200₀ to 200ₙ encrypts the generated key and delivers the encrypted key to the other encryption processing units. Each of the other encryption processing units 200₁ to 200ₙ decodes the encrypted key and holds the same key as that generated in the specific encryption processing unit 200₀. It is, therefore, possible to share the same key among a plurality of encryption processing units 200₀ to 200ₙ, for all of the encryption processing units 200₀ to 200ₙ to execute the same encryption processing and thereby to disperse encryption processing load.

In addition, according to one embodiment of the present invention, the plural encryption processing units 200₀ to 200ₙ keep the keys held therein consistent with one another. It is, therefore, possible to correct the inconsistency of the key resulting from a power failure or the like which occurs when the same key is shared among the units.

One embodiment of the present invention has been explained in detail with reference to the drawings. The concrete example of the constitution of the invention is not limited to this embodiment. Any changes or modifications in design within the scope of the present invention are included in the present invention.

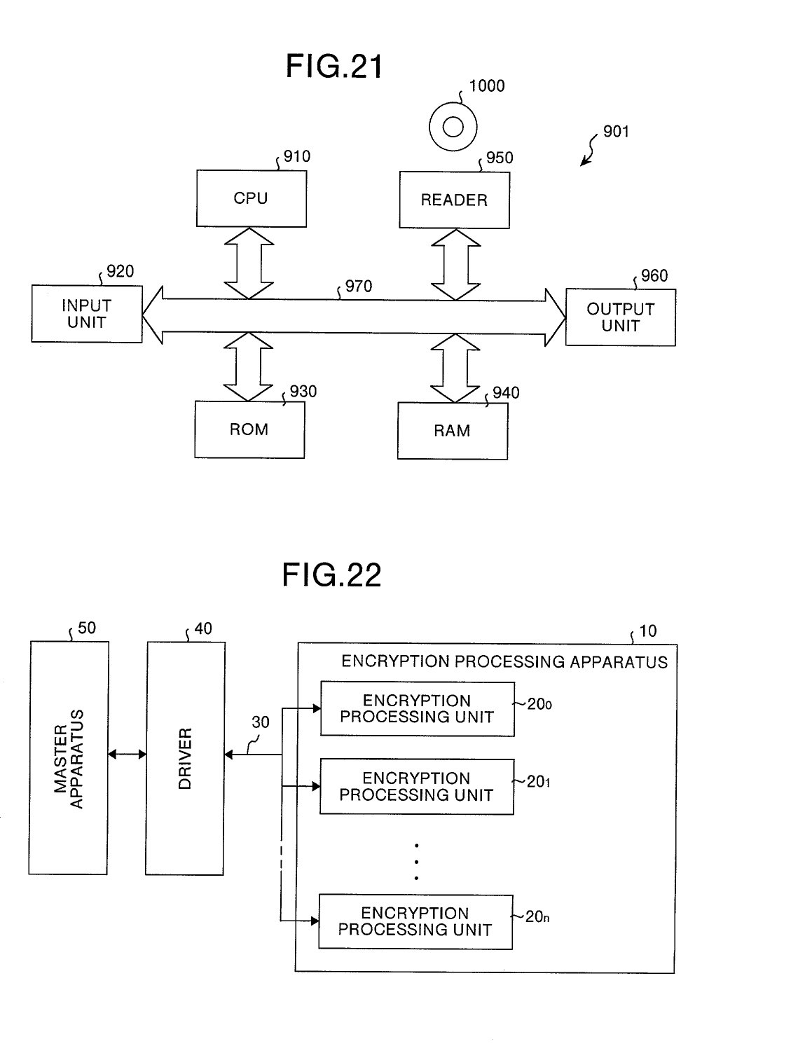

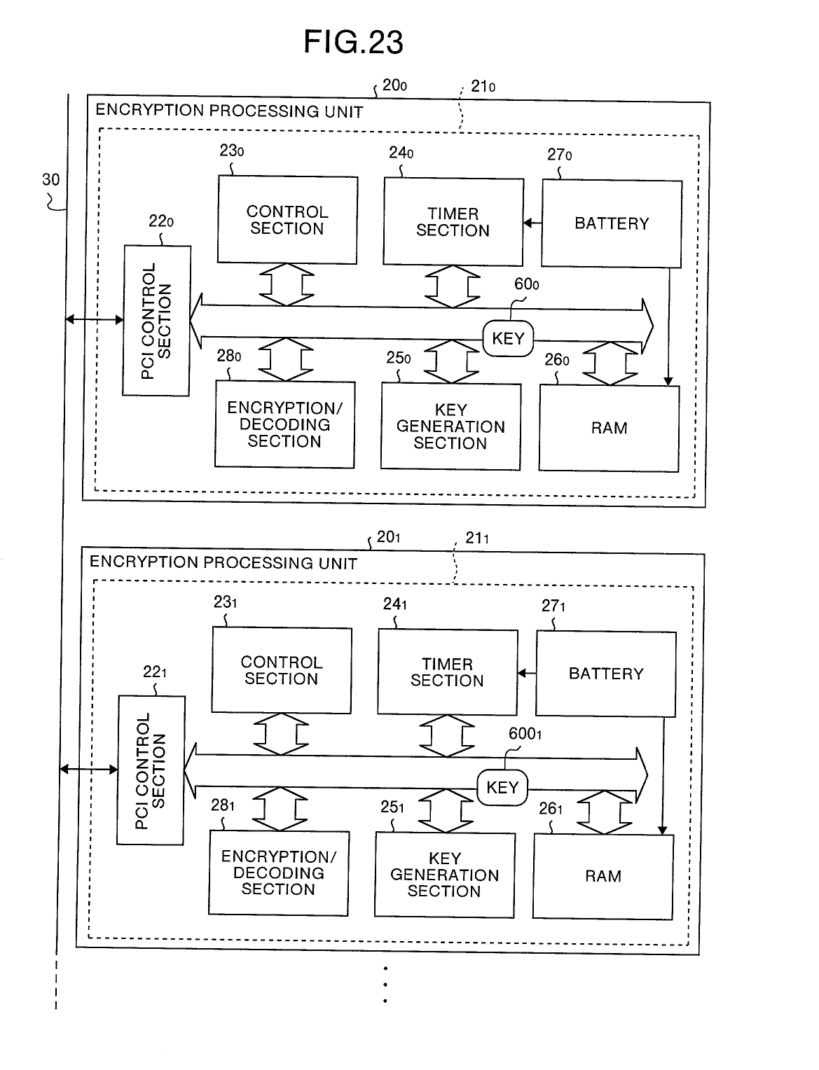

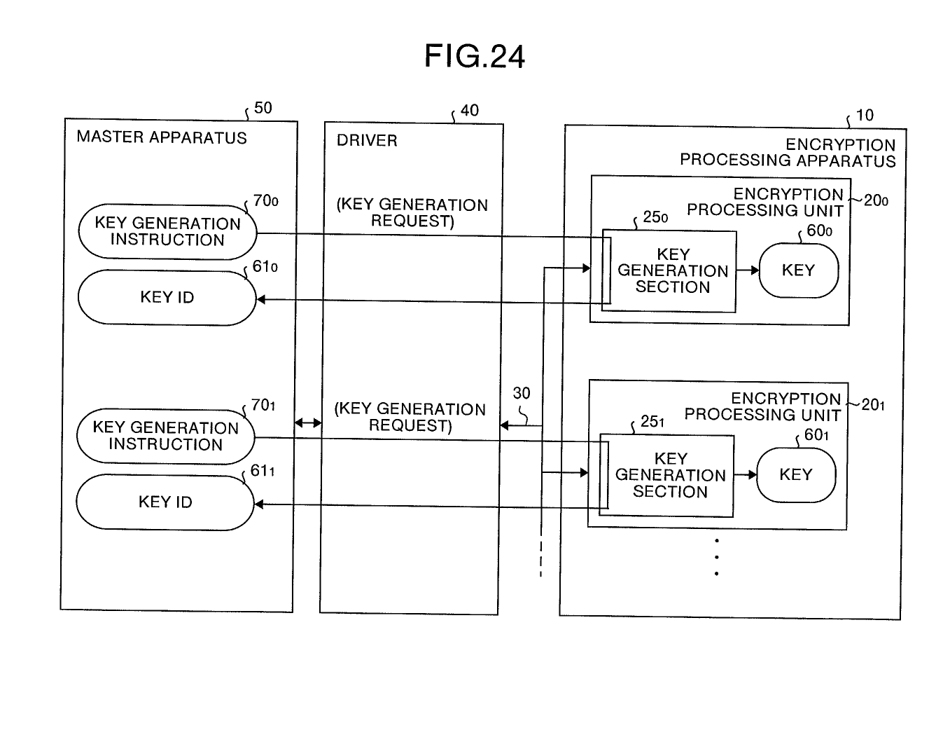

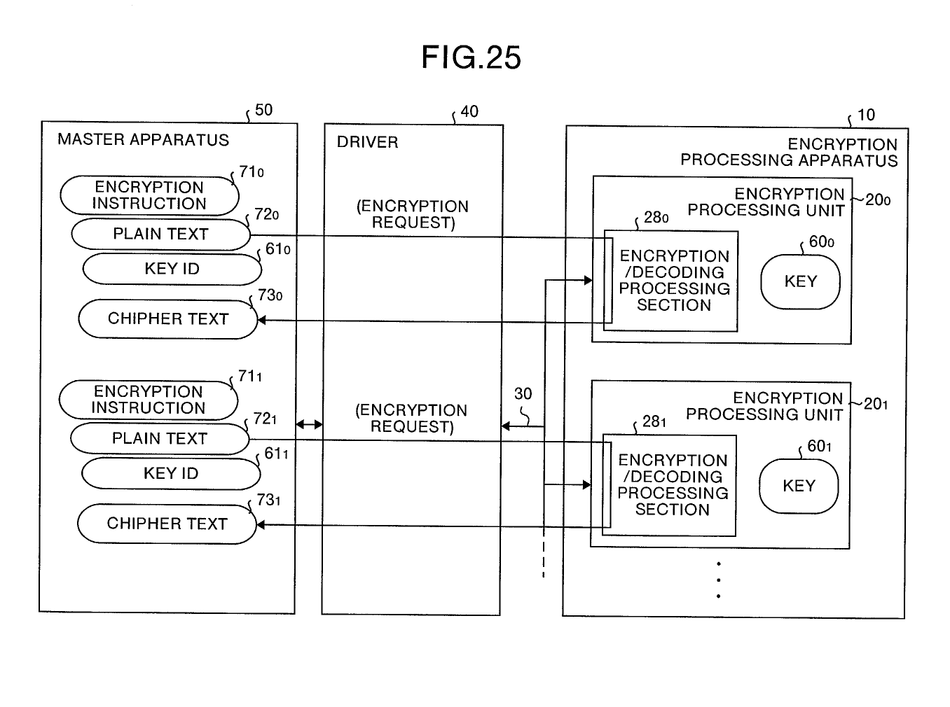

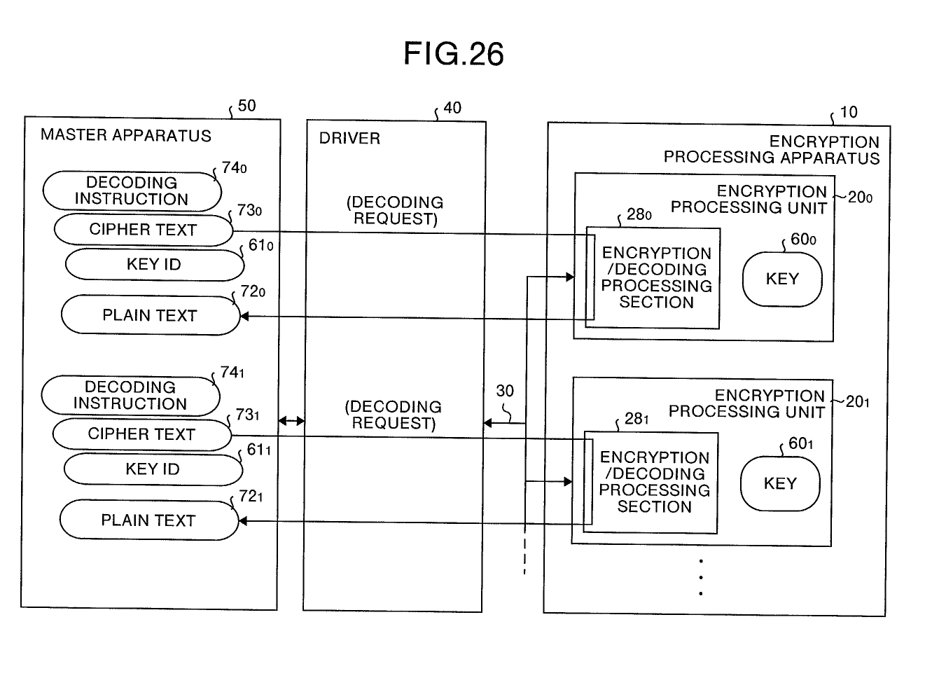

For example, in one embodiment explained above, the respective functions of the driver 400, the encryption processing apparatus 100 and the encryption processing units 200₀ to 200ₙ shown in FIG. 1 may be realized by recording a program which executes the respective functions of the driver 400, the encryption processing apparatus 100 and the encryption processing units 200₀ to 200ₙ shown in FIG. 1 on a computer readable recording medium 1000 shown in FIG. 21, and by allowing a computer 901 shown in FIG. 21 to read and execute the program recorded on this recording medium 1000.

The computer 901 shown in FIG. 21 consists of a CPU (Central Processing Unit) 910 which executes the above program, an input unit 920 such as a keyboard and a mouse, an ROM 930 which stores various data, a RAM 940 which stores operation parameters or the like, a reader 950 which reads the program from the recording medium 1000, an output unit 960 such as a display and a printer, and a bus 970 which connects the respective sections of the computer 901.

The CPU 910 realizes the above-stated respective functions by reading the program recorded on the recording medium 1000 through the reader 950 and executing the program. The recording medium 1000 is exemplified by a portable recording medium such as an optical disk, a flexible disk or a hard disk.

As explained so far, according to one aspect of the present invention, stores the decoded key holds a same key as the key that is the same key as the one generated by the encryption processing unit the same key is advantageously shared among a plurality of encryption processing units, any encryption processing unit among the plurality of encryption processing unit can advantageously carry out the same encryption processing, and encryption processing load can be advantageously dispersed. Moreover, the keys held are kept consistent with one another in a plurality of encryption processing units. Therefore, the inconsistency of the keys resulting from a power failure or the like which occurs during the common processing using the same key, can be advantageously corrected.

Furthermore, according to another aspect of the present invention, the same key is advantageously shared among a plurality of encryption processing units, any encryption processing unit among the plurality of encryption processing unit can advantageously carry out the same encryption processing, and encryption processing load can be advantageously dispersed. Moreover, each of the plurality of encryption processing units is instructed to perform a key consistency processing to keep the keys held by the plurality of encryption processing units consistent with one another. Therefore, the inconsistency of the key resulting from a power failure or the like which occurs during the common processing using the same key, can be advantageously corrected.

Furthermore, according to still another aspect of the present invention, if the encryption processing apparatus consists of a plurality of encryption processing units, the same key is advantageously shared among the plural encryption processing units, any encryption processing units among the plurality of encryption processing unit can advantageously carry out the same encryption processing, and encryption processing load can be advantageously dispersed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An encryption processing apparatus comprising a plurality of encryption processing units each of which executes an encryption processing, wherein
at least one of the encryption processing units generates a key, encrypts the key and delivers the encrypted key to other encryption processing units that have not generated the key, and
each of the other encryption processing units decodes the received key, and stores the key as the key that is the same key as the one generated by the at least one encryption processing unit.

2. The encryption processing apparatus according to claim 1, wherein each of the encryption processing units comprises a consistency unit which keep a consistency of the key stored by that encryption processing unit with the key stored by the other encryption processing units.

3. An encryption processing unit control apparatus comprising:
an encrypted key generation instruction unit which issues an instruction to generate a key, encrypt the generated key and transmit the encrypted key, to a specific encryption processing unit among a plurality of encryption processing unit each of which executes an encryption processing; and
an encrypted key decoding unit which issues an instruction to deliver the encrypted key, decode the encrypted key and hold the same key as the key generated by the specific encryption processing unit, to the other encryption processing units.

4. The encryption processing unit control apparatus according to claim 3, comprising a consistency processing instruction unit which instructs each of the plurality of encryption processing units to perform a key consistency processing to keep the keys stored by the plurality of encryption processing units consistent with one another.

5. An encryption processing control unit comprising:
a key generation unit which generates a key in accordance with an external key generation instruction;
an encrypted key generation unit which generates an encrypted key obtained by encrypting the key to be delivered to the other encryption processing units based on an external encrypted key generation instruction, and then transmits the encrypted key to an outside of the encrypted key generation unit; and
an encrypted key decoding unit which decodes the delivered encrypted key and holds the same key as the key held by the encryption processing unit which generates the key based on an external encrypted key decoding instruction.

6. A computer program which allows a computer to function as:
an encrypted key generation instruction unit which issues an instruction to generate a key, encrypt the generated key and transmit the encrypted key, to a specific encryption processing unit among a plurality of encryption processing unit each of which execute an encryption processing; and
an encrypted key decoding unit which issues an instruction to deliver the encrypted key, decode the encrypted key and hold the same key as the key generated by the specific encryption processing unit, to the other encryption processing units.

7. A computer program which allows a computer to function as:
a key generation unit which generates a key in accordance with an external key generation instruction;
an encrypted key generation unit which generates an encrypted key obtained by encrypting the key to be delivered to the other encryption processing units based on an encrypted key generation instruction, and then transmits the encrypted key to an outside of the encryption processing apparatus; and
an encrypted key decoding unit which decodes the delivered encrypted key and holds the same key as the key held by the encryption processing unit which generates the key based on an external encrypted key decoding instruction.
